(19) United States
(12) Patent Application Publication
(10) Pub. No.: US 2013/0256535 A1
(43) Pub. Date: Oct. 3, 2013

(54) TERAHERTZ RADIATION DETECTION USING MICRO-PLASMA

(71) Applicants: Afric Simone Meijer, EB Nijmegen (NL); Willem Joan Van Der Zande, TG Bussum (FR)

(72) Inventors: Afric Simone Meijer, EB Nijmegen (NL); Willem Joan Van Der Zande, TG Bussum (FR)

(73) Assignee: TeraOptronics B.V., EB Nijmegen (NL)

(21) Appl. No.: 13/992,341

(22) PCT Filed: Dec. 7, 2011
(86) PCT No.: PCT/NL2011/050839

§ 371 Date: Jun. 7, 2013

(30) Foreign Application Priority Data
Dec. 10, 2010 (NL) 2005856

(51) Int. Cl. G01J 5/02

(52) U.S. Cl. CPC G01J 5/02
USPC 250/340; 250/338.1; 250/349

(57) ABSTRACT

Detector for terahertz radiation with a micro-plasma cell (1) having a cavity (5) including a plasma in operation when applying a DC bias to the micro-plasma cell (1). Furthermore, the detector is provided with read-out electronics (20) connected to the micro-plasma cell (1). The read-out electronics measure changes of an electron density in the plasma in the micro-plasma cell (1) with respect to the DC bias provided electron density. The cavity (5) includes a gas composition near atmospheric pressure or higher, and the gas composition includes a Penning mixture.

### FIELD OF THE INVENTION

The present invention relates to a detector for terahertz radiation, a method of detecting terahertz radiation and an image sensor.

### PRIOR ART

American patent publication US2004/0100194 discloses a micro-discharge photo-detector used as light detector. The photo-detector comprises a cavity in a semiconductor substrate, on which an insulating layer isolates an anode layer from the semiconductor substrate acting as cathode. When the cavity is filled with a proper gas and a proper voltage is applied between anode and cathode, a plasma is formed in the cavity. The gas is disclosed as a single rare gas, single N₂ gas, gas mixtures with vapor (e.g. Ar/Hg), mixtures with halogen bearing molecules, or a mixture of Xe and O₂/N₂O/NO₂. Light with a photon energy larger than about a work function of the cathode material impinges on the photocathode and causes an avalanche breakdown in the plasma. This avalanche breakdown may be detected as an increase in light emission or increase in current flowing in the photo-detector.

### SUMMARY OF THE INVENTION

The present invention seeks to provide a detector which is particularly suitable for detecting radiation in the terahertz range. Such radiation is not providing the effect as in the prior art photo-detector described above.

According to the present invention, a detector for terahertz radiation is provided comprising a micro-plasma cell with a cavity comprising a plasma in operation when applying a bias to the micro-plasma cell, and read-out electronics connected to the micro-plasma cell measuring changes of the electron density in the plasma in the micro-plasma cell with respect to the bias provided electron density, wherein the cavity comprises a gas composition near atmospheric pressure or higher, and the gas composition comprises a Penning mixture.

This detector uses the effect of terahertz radiation on the plasma due to absorption by the electron cloud in the plasma or ionization of highly excited neutral atoms (or Rydberg atoms). Each signal electron is multiplied in the enhanced cascade ionization process and thus provides for a detector, which can be manufactured using techniques known as such, e.g. CMOS manufacturing.

In further embodiments, the Penning mixture comprises a main inert gas, and a quench gas having a lower ionization potential than the main inert gas. The main inert gas is e.g. Ne, and the quench gas Ar or Xe. The quench gas may also be molecular, for instance O₂ or CF₄. In one specific example, the Penning mixture comprises Ne and at least 0.5 vol. % Xe.

The micro-plasma cell comprises a first electrode and a second electrode, the first electrode being a tuned electrode, in a further group of embodiments. The tuned electrode e.g. comprises a metamaterial which forms a periodic structure that compromise highly conductive materials and/or shaped metals, such as graphene, gold or copper, wherein the periodic structure has structural features smaller than the wavelength of the terahertz radiation. The tuned electrode may furthermore comprises one or more split ring resonators. In a further embodiment, the tuned electrode comprises metamaterial structures with more than one layer stacked on top of each other and spaced by a dielectric.

The tuned electrode allows to enhance the detection of terahertz radiation towards higher terahertz frequencies (>1 THz) and to create frequency selective terahertz micro plasma detectors.

In an even further embodiment, two or more micro-plasma cells having tuned electrodes of different resonant frequencies are grouped into a single image pixel. This can be implemented effectively by combining two or more micro-plasma cells with a differently implemented tuned electrode. Radiation (frequency) sensitivity can then easily be tuned for specific applications.

The micro-plasma cell is driven by a DC bias in a further embodiment, and the read-out electronics comprise DC-bias decoupling components. E.g. a resistor in series with the micro-plasma cell and a decoupling capacitor may be provided. Alternatively, the micro-plasma cell is driven by an AC bias unit, the first and second electrode are isolated from the cavity, and the read-out electronics comprise a network analyzer.

In a further embodiment, the detector further comprises a radiation source irradiating the plasma in the micro-plasma cell. The radiation source is e.g. a pulsed or continuous wave laser source. The radiation source enlarges the number of highly excited neutral atoms (or Rydberg atoms) in the plasma, thus increasing the sensitivity of the detector. The cavity of the micro-plasma cell is near atmospheric pressure (i.e. at reduced or at atmospheric pressure) or higher, in order to further enhance sensitivity of the detector in a further embodiment.

The micro-plasma cell, in a specific group of embodiments, comprises a substrate provided with a thin film first electrode or cathode, a dielectric layer and a conductive anode or second electrode layer, the dielectric layer being provided with an aperture above the thin film first electrode (cathode) forming the cavity. This structure is also known in the field as Grimm configuration, and allows processing of the detector using substrate processing techniques known as such.

In an embodiment of the present detector the conductive anode layer comprises apertures above the cavity. Sufficient structure is available in order to generate a micro plasma in the micro-plasma cell. In an alternative embodiment, the conductive anode layer comprises a material transparent to radiation having a wavelength in the 50-3000 μm range, such as ITO or MgO on quartz. This allows to close off the aperture of the micro-plasma cell effectively.

In a further aspect, the present invention relates to a method of detecting terahertz radiation, comprising generating a plasma in a sensor cavity using a bias, the plasma having a bias provided electron density, and detecting changes in the electron density in the plasma with respect to the bias provided electron density by measuring a current change, wherein the cavity comprises a gas composition near atmospheric pressure or higher, and the gas composition comprises a Penning mixture.

In an embodiment the method further comprises using a detector according to any one of the embodiments described above.

In an even further aspect, the present invention relates to an image sensor comprising an array having a plurality of detectors according to one of the present invention embodiments. Such an image sensor provides for a very cost efficient image sensor for terahertz radiation. The array has a pixel size of between 1 and 500 μm in a further embodiment.

The micro-plasma cells and read-out electronics of each of the array of detectors may be formed on a single substrate in a further embodiment. This allows manufacturing using known techniques and thus allows a very cost-efficient image sensor.

In a further embodiment, the image sensor further comprises imaging optics (for the relevant radiation wavelength range), which may even be integrated with the image sensor. In an even further embodiment the image sensor further comprises an optical window covering the detectors. Such an optical window may effectively close off each cavity in each micro-plasma cell.

In the present embodiment structure of the terahertz radiation detector, the radiation provides for an effect in the plasma itself, not only by impinging on the photocathode. In other words, the plasma is used as sensitive medium in the terahertz radiation sensor of the present invention embodiments.

### SHORT DESCRIPTION OF DRAWINGS

The present invention will be discussed in more detail below, using a number of exemplary embodiments, with reference to the attached drawings, in which

FIG. 1 shows a perspective view of a detector according to an embodiment of the present invention;

FIG. 2 shows an exploded view of an image sensor according to an embodiment of the present invention; and

FIG. 3 shows a schematic diagram of a detector with associated pixel sensor electronics.

### DETAILED DESCRIPTION OF EXEMPLARY EMBODIMENTS

Imaging techniques for far-infrared radiation in the terahertz (THz) frequency regime have obtained considerable attention in the last decades. Advances in generation and detection of ultra-short THz pulses with a spectrum from a few gigahertz to 3 THz and the interest for non-ionizing radiation for medical and material-probing applications have triggered a fast development of imaging techniques. Most reported THz imaging experiments are based on the coherent detection technique of time domain spectroscopy (TDS). Femto-second lasers are used in combination with lens-coupled semiconductor antennas or the electro-optic effect in ZnTe as THz source and receiver. The transmitted or reflected THz pulse shape is measured and used to reconstruct absorption or phase delay images. Two-dimensional imaging of high-power THz radiation has been demonstrated and used to image moving samples in real time. Using the temporal profile of a reflected pulse, three-dimensional tomograms have been obtained. Imaging of continuous THz radiation generated by frequency mixing has also been accomplished.

Simple room temperature THz detectors sensitive for incoherent radiation are readily found, but two-dimensional imaging sensors are scarce. Pyro-electric detectors, cooled bolometers and Golay cell detectors yield a great sensitivity, but only at the expense of decreased response speed. Existing passive standoff terahertz cameras based on micro-bolometer technology operate only at several distinct frequencies below 1 THz. However, these THz cameras are compact, portable and easy-to-use products capturing pictures of natural THz radiation emitted by almost everything.

Gas micro-discharge cells represent a new family of room temperature sensors having sensitivities that compromise an uncooled bolometer or thermopile and are able to detect incoherent millimetre, microwave and far-, mid- and near-infrared, visible and UV radiation. The speed of response of the gas discharge cells is limited not by the detection mechanism, but by the parasitic reactance and therefore may be sub microsecond. The induced current changes in the micro-plasma cells by radiation are detected using opto-galvanic techniques, which may involve a capacitor to decouple the direct current (dc) bias and allows to sensitive detection of small voltage differences. This technique allows one to perform high resolution spectroscopy on atoms and molecules inside plasmas and observe resonant lines without amplification with a signal-to-noise ratio about 10². However, off-resonant detection of induced perturbations of the plasma by electromagnetic radiation is very weak and requires 30 to 40 db amplification. Ultra violet (UV), visible (VIS), near-, mid-, and far-infrared (IR), and microwave are detectable with a noise equivalent power (NEP) compromising an UV-S5 photocathode tube, and IR uncooled bolometers and thermopiles. As the micro-plasma cell are active pixel sensors and do not have capacity to store the induced signal for readout, CMOS active pixel sensor technology is integrated with the micro-plasma cells to provide digitalizing of the induced signal for further computer processing of the obtained images.

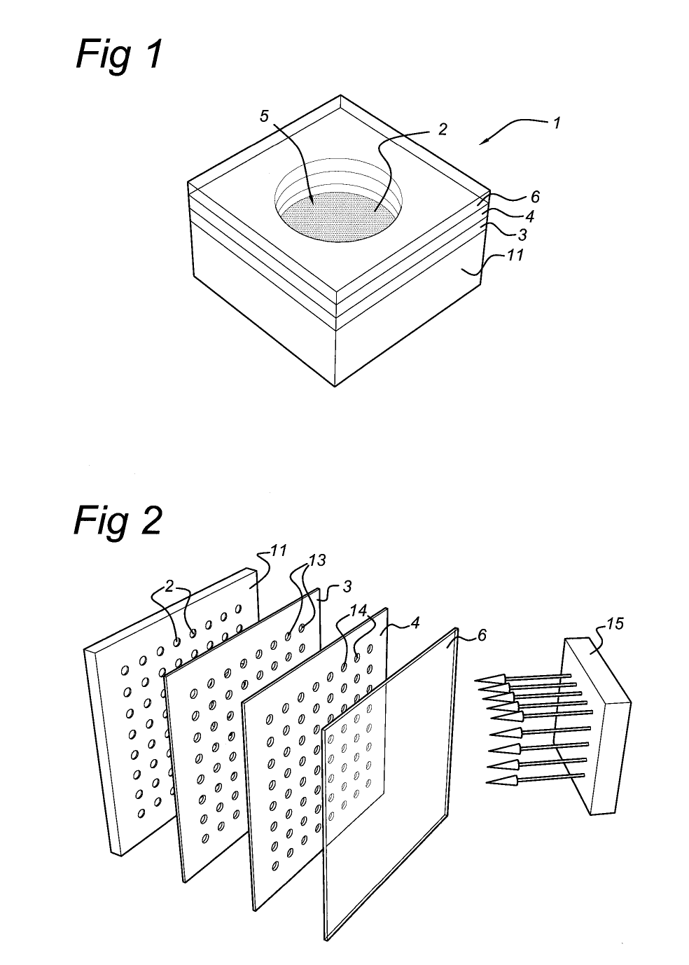

A first embodiment of a detector for terahertz radiation is shown schematically in the perspective view of FIG. 1. The detector comprises a micro-plasma cell 1 having a first (cathode) electrode 2 in the form of a thin film conductive material, such as a thin film metal, and a conductive second electrode (anode) 4. Between the first electrode 2 and second electrode 4, an insulating material 3 is provided, e.g. in the form of a dielectric material. A cavity 5 is provided in the insulating material 3, the cavity 5 comprising a gas for forming a micro-plasma when e.g. a DC bias is applied to the first electrode 2 and second electrode 4. An optical window 6 transparent for terahertz radiation may close the cavity 5 to form a closed container, the optical window e.g. compromising quartz and polymers.

The gas molecules used in the micro plasma terahertz detector consist of more than one gas in a Penning mixture, like Neon-Xenon. One of the most significant characteristics of such a Penning mixture is the enhancement of the ionization coefficient of the resulting mixture over that of either constituent, a lowering of the first electrode 2 fall potential and a decrease in breakdown potential. Thus, the use of a Penning mixture is of advantage for detecting microwave and terahertz radiation, because it increases the electron density in the micro plasma and increases the electron cascade or avalanche effect for signal electrons produced by electromagnetic (EM) radiation, e.g. in the terahertz range.

A very common Penning mixture of about 98%-99:5% of neon with 0.52% of argon. The optimal amount of argon admixture is about 0:1%, but some of the Ar gets absorbed into the materials like glass, so higher concentrations are used to take the losses in account.

A Penning mixture is defined as a mixture of one inert gas with a minute amount of another gas, one that has lower ionization voltage than the main constituent (or constituents). The other gas, a quench gas, has to have lower ionization potential than the first excited state of the noble gas. The energy of the excited noble gas atoms then can ionize the quench gas particles by energy transfer via collisions; known as the Penning effect.

The main gas component in the Penning mixture is chosen from a group of inert gases, such as Argon, Neon, Xenon, or mixtures thereof. For e.g. tracing a further component can be added to the gas, such as ethylene.

The insulating material 3 in this embodiment extends deeper than the cathode electrode 2, as a result of which the cathode electrode 2 is surrounded by insulating material 3 with the exception of the part adjacent to the cavity 5, which is in contact with the gas in the cavity 5. The structure of the detector can also be described as a micro hollow cathode configuration, Grimm configuration or flat electrode configuration.

In FIG. 2 an exploded view is shown of the structure of an embodiment of an image sensor 10 according to the present invention. An array of cathode electrodes 2 is provided on a substrate 11. A further layer 12 of insulating material is provided, having apertures 13 which eventually form the cavities 5 of the array of detectors 1. Finally, a conductive anode layer 4 is provided, which in this embodiment is provided with apertures 14 which are aligned with the apertures 13 in the further layer 12. As in the embodiment shown in FIG. 1, an optical window 6 may be used to form a closed container, the optical window 6 e.g. compromising quartz and polymers.

In a further embodiment, the conducting anode layer 4 is composed of a transparent material (for the terahertz radiation) or a combination of transparent materials, such as an indium-tin-oxide (ITO) or magnesium oxide (MgO) layer on a quartz glass plate. The transparent anode layer 4 may then fulfil the function of the optical window 6 for closing of the cavities 5, and the separate optical window may be omitted.

In FIG. 2 furthermore a radiation source 15 is shown, which in further embodiments of the present invention is used in operation to irradiate the plasma in the cavities 5 of the array of the micro-plasma cells 1.

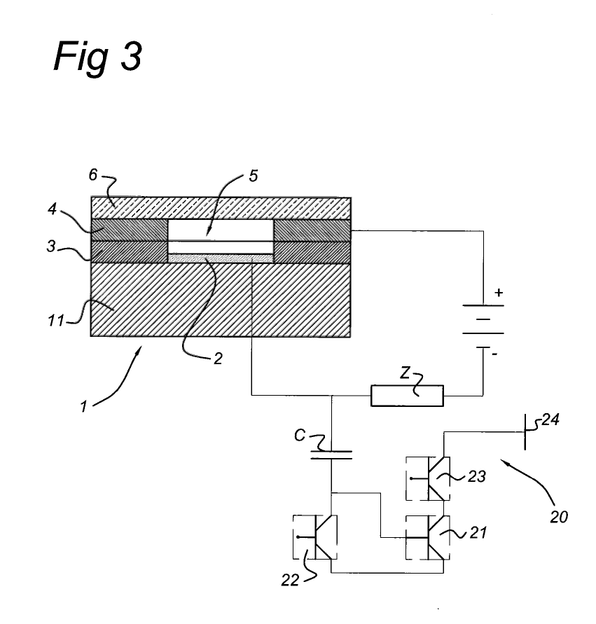

In an embodiment of the present invention, a detector for detecting terahertz radiation is provided comprising a micro-plasma cell 1 as shown in FIG. 1 with a cavity 5 comprising a plasma in operation when applying a DC bias to the micro-plasma cell 1. Furthermore, the detector comprises read-out electronics 20 connected to the micro-plasma cell 1 measuring an electron density increase in the plasma in the micro-plasma cell 1 beyond the DC bias provided electron density. This is schematically shown in FIG. 3, where the (cathode 2 of) the micro-plasma cell 1 is connected to read-out electronics 20, comprising a capacitor C, an amplifier 21, a reset cell 22 and a row select transistor 23, eventually connected to a column bus 24 in the embodiment shown. The cathode 2 and anode 4 of the micro-plasma cell 1 are supplied with power from a battery and impedance Z in this embodiment. Alternatives for the read-out electronics 20 are conceivable, such as a specific arrangement allowing peak detection in noisy signals, e.g. using a lock-in amplifier. The read-out electronics 20 may thus be easily integrated using circuit techniques which are known as such (e.g. CMOS processing).

Each micro-plasma cell 1 in an array forming the image sensor 10 is thus connected to an active (CMOS) pixel sensor for read-out and storage of the terahertz radiation induced signal in each micro-plasma cell 1. This allows to process and display an image obtained using the image sensor 10, e.g. using a computer system.

It is noted that the read-out electronics 20 can be integrated in the substrate 11 of the image sensor 10, allowing to provide a very compact image sensor 10, which can be produced using known semiconductor processing techniques, such as CMOS processing.

The detection mechanism of the micro-discharges in the present invention embodiments uses the intrinsic properties of the electrons, atoms or molecules in the gas plasma as generated in the cavities 5. In the microwave and millimetre regime, absorption in micro-plasmas changes the average kinetic energy of electrons, which cause an increase of the electron density beyond that provided by the DC bias supplied to the cathode electrode 2 and conducting anode layer 4.

The micro-discharge cells 1 allow operation at reduced pressure, but in a further embodiment also at atmospheric pressures or even higher, with the advantage that the electron density will increase with increasing pressure. Therefore also the sensitivity of the micro-plasma cells 1 for low energy photons is enhanced. The average collision frequency of electrons with gas atoms or molecules will increase with increasing pressure towards higher frequencies in the range of THz radiation and resonant detection becomes possible. Also the plasma frequency of electrons will increase with increasing pressure towards THz frequencies. As the photon energy of the electromagnetic radiation increases towards the far-, mid- and near-infrared the dominated detection mechanism becomes enhanced ionization of highly excited neutral atoms, also Rydberg atoms, naturally present in plasma's. Photo-ionized atoms in the plasma are accelerated towards the cathode 2 and create secondary electrons at impact, which is a further increase of the electron density beyond that provided by the dc bias.

The meta-stable atoms and molecules may be used as precursor for selectively increasing the Rydberg atom population in the plasmas with pulsed or continuous wave lasers (e.g. in the form of the radiation source 15 as described with reference to FIG. 2 above), which provide the gas discharge cell 1 several orders of higher sensitivity. Additionally, frequency selective detection becomes possible as infrared photons ionizing the Rydberg atoms near the ionization threshold have a higher ionization probability and therefore higher detection efficiency. Although the density of gas-phase Rydberg atoms is very low (˜10¹¹ cm⁻³ atoms) compared with solid-state detectors, the combination of a low ionization threshold with a high photo-ionization cross section, makes a Rydberg atom a very sensitive detector for infrared radiation. Each signal electron produced by electromagnetic radiation is enhanced by the strong abnormal glow dc field, and produces additional electrons in cascade or avalanche signal collision processes. The result is an internal signal electron multiplication gain of about 10⁶, which is comparable with a two stack micro channel plate (MCP).

In an embodiment, the detection of micro wave and terahertz radiation in micro discharges is based on the current change ΔI in the electric circuitry of the read-out electronics 20 with applied (bias) current I when a modulated electromagnetic (EM) field is present. The frequency of this variation or current change is the same as that of the EM pulse modulation and can be detected by the series resistor R and visualized as a pulse variation of the potential U by ΔU when the DC component of U is decoupled by a capacitor C. According to Ohm's law: ΔU=ΔlR_{D}, where R_{D} is the differential resistance of the discharge. These micro discharge detectors are able to operate at modulation frequencies of 0.01-1000 KHz.

Operating the micro discharges in the abnormal discharge regime of the plasma in the cavity 5, the differential resistance is large and has a positive slope until the transition into the arc discharge regime. The EM field primarily affects the electrons by a periodic force, which change increases their average kinetic energy. This electron heating effect by EM radiation increases the current ΔI by enhanced collision ionization beyond that is provided by the DC bias and causes a voltage drop AU, which is negative, because the total supply voltage is stabilized. The efficiency of this differential detection method in micro discharges, also called optogalvanic measurements, is optimized when the energy transfer from the EM field to the electrons is set to its maximum. Solving the equation of motion of the change of the electron average kinetic energy due to an EM field, the term

$$\frac{{nv}_{eff}}{( {ω}^{2} + {v}_{eff}^{2} )}$$

appears, where n is the electron density in the micro discharge, ω the EM frequency and ν_{eff} the effective collision frequency between electrons and gas particles, and is optimized when ω=ν_{eff}. Thus, the absorption of EM radiation by the electron cloud in the micro discharge is optimized when electrons collide with gas particles within a half a cycle of the EM field, before the EM field changes direction and extract energy from the electron cloud. Also, a high electron density in the micro discharge improves the detection of EM radiation. The effective collision frequency, the strongest detected EM frequency and the electron density are pressure depended and are optimized for microwave and terahertz radiation by increasing the gas pressure towards atmospheric pressures. Therefore, micro discharges are used which fulfil the Pashen law: dp=constant, where d is the distance between electrodes [cm] and p is the pressure [Torr]

To increase the electron density even further, micro hollow cathode discharges are used. The pendulum effect in the hollow cathode increases the ionization collision rate significantly. The electrons, which are accelerated in the cathode fall, passes the negative glow where they excite and ionize neutral molecules, and then are entering the opposite negative glow and cathode fall in a retarding field. Finally, they will be accelerated again and repelled into the negative glow from the opposite side of the cathode. As a consequence of the motion from side to side of the cathode cavity, the fast electrons are kept in the cathode zone for longer time, until they lose enough energy to be extracted towards the anode and the ionization efficiency increases. The excited neutral atoms are not affected by the applied electric, but may produce secondary electrons when impinging on the cathode. In planar cathode configuration excited neutrals are easily lost, but in the hollow cathode configuration, the cylindrical shape and large surface will increase the secondary electron emission. The enhancement of the discharge efficiency depends on the hollow cathode geometry, the cathode material, the fill gas and the working pressure. Also, hollow cathodes are favourable because of the wide positive slope of the discharges, allowing them to be placed in parallel without using a ballast resistor for each single discharge cell.

Each electron produced by the enhanced collision ionization due to heating of the electron cloud by EM radiation produces additional electrons in a cascade or avalanche signal collision process. This results in an internal signal electron multiplication gain on average of ˜10⁶ per signal electrons and is assumed to remain constant with increasing pressure.

The micro-plasma or micro-discharge cell 1 allows to be miniaturized into a micro-array with pixel size up to 100 μm, without compromising the detection of electromagnetic radiation. An example is shown in exploded view in FIG. 2 as already described above, where e.g. a 30 mm×30 mm substrate 11 is used. The thickness or height of each cavity 5 may be in the order of 10-100 μm. The pitch distance between individual micro-plasma cells 1 may be in the order of 0.1-1 mm, wherein the cavity diameter may be between 0.01 and 0.5 mm

This would also allow the addition of an imaging optics, e.g. a lens system transparent for the detectable radiation, for imaging an object in free space onto the micro-plasma cell array 10.

The micro plasma terahertz detector is created using a conductive material as cathode/first electrode 2 of arbitrary thickness by not less than 100 nm, a dielectric 3 as insulator electrically separating the two electrodes 2, 4 ranging from 1 μm to 100 μm to fulfil the Paschen law of pd=constant and a conductive material as anode/second electrode 4 of thickness not more than 1 μm.

The micro holes (cavities 5) in the micro plasma terahertz detector have dimensions from 50 μm to 500 μm diameter to sustain a stabile micro glow discharge. The depth of each hole ranges from 1 μm to 500 μm. The amount of micro holes in the micro plasma terahertz detector may differ from application and can range from 1 to more than 1024 in a line to create a line sensor, and from 2×2 to more than 256×256 micro holes to from an image detector. The distances between micro holes are close to the diameter of the holes and can be decreased to enlarge the amount of micro holes per surface or increased.

The micro plasma holes in the micro plasma terahertz detector can also be formed in patterns, figures or clusters to create dedicated sensors for special purposes, like coincidence measurements.

Among large variety of commercially available materials for windows and lenses, quartz and polymers; TPX (polymethylpentene), polyethylene (PE), polypropylene (PP), and polytetrafluoroethylene (PTFE or Teflon), have excellent UV, VIS and terahertz transparencies. However, in order to cover also the near- and mid-infrared from 0.8-20 μm will involve a combination of different materials.

The imaging sensor 10 according to any one of the embodiments described can be processed by a combination of photolithographic and micromachining processing techniques. All these features combined create a unique, low cost and versatile terahertz camera or imaging sensor for industrial applications, including but not limited to product inspection on conveyor-belts, medicine, communication, homeland security and space technology, and scientific applications like two-dimensional terahertz dynamics with free electron lasers.

Further enhancement of the micro-discharge cell 1 is obtained in further embodiments, where a tunable cathode electrode 2 is used.

In an embodiment of the present invention, metamaterials (MMs) are used as cathode material in micro plasma terahertz detectors to enhance the detection of terahertz radiation, extending the detection towards higher terahertz frequencies (>1 THz) and additionally create frequency selective terahertz micro plasma detectors. Resonances in MMs have remarkably large oscillator strengths, resulting in narrow absorption peaks without cryogenic cooling. Terahertz metamaterials are metamaterials which interact at terahertz frequencies. For research or applications of the terahertz range for metamaterials and other materials, the frequency range is usually defined as 0.1 to 10 THz. This corresponds to the millimeter and submillimeter wavelengths between 3 mm (EHF band) and 0.03 mm (long-wavelength edge of far-infrared light).

Metamaterials are artificial sub-wavelength unit cell systems, which form a periodic structure that comprise highly conductive and shaped metals, such as gold or copper. Metamaterials gain their properties from structure rather than composition and affects electromagnetic radiation (EM) by having structural features smaller than the wavelength of light. These periodic units cell systems have shaped structures, such as split ring resonators (SRR), which affects the complex dielectric properties of the effective medium, both electric as magnetic, and thereof their response to electromagnetic (EM) radiation. Split ring resonators are defined by a width and thickness of the ring, length or diameter of the ring, and the gap distance.

As effective media, metamaterials can be characterized by a complex refractive index ñ(ω)=\sqrt{\tilde{∈}(ω)\tilde{μ}(ω)}=n₁(ω)+in₂(ω), where n₁ is related to the phase velocity and n₂ to losses, \tilde{∈}(ω)=∈₁(ω)+i∈₂(ω) to the complex electrical permittivity and \tilde{μ}(ω)=μ₁(ω)+iμ₂(ω) to the complex magnetic permeability.

By fabricating metamaterial structures with more than one layer compromising an artificial unit cell, which are stacked on top of each other and spaced by a dielectric, it also becomes possible to simultaneously tune \tilde{∈}(ω) and \tilde{μ}(ω) towards high absorption of EM radiation close to unity. Recent metamaterials research focuses largely on applications related to engineering negative refractive index materials with minimized losses. However, for the application in terahertz detectors, tailoring metamaterials featuring high losses and thereby high absorption of EM radiation, absorbers may be created that could serve as EM antennas in the terahertz regime in combination with micro plasma detectors.

Metamaterials feature resonances, depending on the dimensions of the unit cell, corresponding to absorption of EM and induces an alternating current in the metallic shaped structure and ohmic heating. In case a metamaterial is used as cathode 2 in micro plasma terahertz detectors, the absorption of EM radiation changes the electric properties of the cathode 2 and provide an increase of the electron density at the cathode beyond that provided by the (DC) bias. Each electron produced by electromagnetic radiation in the metamaterial is enhanced by the strong abnormal glow dc field, and produces additional electrons in cascade or avalanche signal collision processes. The result is an internal signal electron multiplication gain of about 10⁶, which is comparable with a two stack micro channel plate (MCP).

Engineered micro structures forming metamaterials in micro plasma detectors can be tuned over a broad terahertz frequency range by changing gap widths, structure sizes and electrostatic doping of the used metal in the metamaterial. The gas discharge cell allows to be miniaturized into a micro array with pixel size up to 100 μm. Also, metamaterials are easily fabricated for response in the microwave and terahertz regime including three dimensional (3-D) structures, owing to the relatively large unit cell size (˜0.01-1 cm), smallest required feature size (˜0.01-1 mm)

When two or more metamaterial unit cells with different resonant frequencies are grouped forming a single pixel, a micro plasma terahertz detectors is created which is color sensitive and is able to capture in a single image multiple terahertz frequencies. In this way, fingerprints of chemical compounds in products can be inspected to determine compensation and concentration.

Further embodiments of the present invention relate to a combination of a micro-discharge cell1 and a generator coupled thereto, wherein the generator is a radio frequency (RF) source which capacitively couple to the plasma to excite the gas molecules and form a capacitively coupled plasma (CCP). Free electrons are accelerated in the alternating electric field and gain enough energy to ionize gas molecules and sustain a glow discharge.

Micro plasma terahertz detectors using CCP have isolated electrodes 2, 4, which are separated from the gas by a capacitor. The capacitor is a short circuit for high frequency RF field, but an open circuit for direct current (DC) field. Materials like magnesium oxide (MgO) are excellent capacitors, because it has insulating properties as required for surface charge storage in alternating current (AC) operation and strong secondary electron emission of MgO. Secondary electron emission due to ion-induced impact on the cathode surface are exceptionally effective at driving glow discharge ionization since they gain large amounts of kinetic energy as they are accelerated across the cathode sheath and because they have large opportunities for ionizing collisions as they traverse the entire gap between cathode and anode.

In RF driven micro plasma detectors, an electron cloud is formed at both electrodes and thus both electron clouds contribute to the detection of EM radiation. The change of the discharge impedance due absorption of EM radiation by the electron clouds at the electrodes is attributed to electron heating by EM radiation, like in DC micro plasma detection, and can be measured real-time and ex-situ using a scalar or vector network analyzers (SNA or VNA).

VNA's measure the complex impedance of an electric circuit at a given frequency, like a RF driven micro plasma terahertz detector. The measured change of complex impedance due to EM radiation holds information about the EM signal strength as the real part and the EM phase shift with respect to a reference as the imaginary part of the complex impendence.

A line or image micro plasma terahertz detector is formed by individually readout the complex impedance of each micro plasma using CMOS technology.

The present invention embodiments have been described above with reference to a number of exemplary embodiments as shown in the drawings. Modifications and alternative implementations of some parts or elements are possible, and are included in the scope of protection as defined in the appended claims.

1-20. (canceled)

21. A detector for terahertz radiation comprising a micro-plasma cell with a cavity comprising a plasma in operation when applying a bias to the micro-plasma cell, and read-out electronics connected to the micro-plasma cell measuring changes of an electron density in the plasma in the micro-plasma cell with respect to the bias provided electron density,
wherein the cavity comprises a gas composition near atmospheric pressure or higher, and the gas composition comprises a Penning mixture.

22. The detector of claim 21, wherein the Penning mixture comprises a main inert gas, and a quench gas having a lower ionization potential than the main inert gas.

23. The detector of claim 21, wherein the micro-plasma cell comprises a first electrode and a second electrode, the first electrode being a tuned electrode.

24. The detector of claim 23, wherein the tuned electrode comprises a metamaterial which forms a periodic structure that compromise highly conductive materials and/or shaped metals, such as graphene, gold or copper, wherein the periodic structure has structural features smaller than the wavelength of the terahertz radiation.

25. The detector of claim 23, wherein the tuned electrode comprises one or more split ring resonators.

26. The detector of claim 23, wherein the tuned electrode comprises metamaterial structures with more than one layer stacked on top of each other and spaced by a dielectric.

27. The detector of claim 23, wherein two or more micro-plasma cells having tuned electrodes of different resonant frequencies are grouped into a single image pixel.

28. The detector of claim 21, wherein the micro-plasma cell is driven by a DC bias, and the read-out electronics comprise DC-bias decoupling components.

29. The detector of claim 21, wherein the micro-plasma cell is driven by an AC bias unit, the first and second electrode are isolated from the cavity, and wherein the read-out electronics comprise a network analyzer.

30. The detector of claim 21, further comprising a radiation source irradiating the plasma in the micro-plasma cell.

31. The detector of claim 21, wherein the micro-plasma cell comprises a substrate provided with a thin film first electrode, a dielectric layer and a conductive second electrode layer, the dielectric layer being provided with an aperture above the thin film first electrode forming the cavity.

32. The detector of claim 31, wherein the conductive second electrode layer comprises apertures above the cavity.

33. The detector of claim 31, wherein the conductive second electrode layer comprises a material transparent to radiation having a wavelength in the 50-3000 μm range.

34. A method of detecting terahertz radiation, comprising
generating a plasma in a sensor cavity using a bias, the plasma having a bias provided electron density,
detecting changes in the electron density in the plasma with respect to the bias provided electron density by measuring a current change,
wherein the cavity comprises a gas composition near atmospheric pressure or higher, and the gas composition comprises a Penning mixture.

35. The method of claim 34, further comprising using a detector for terahertz radiation, the detector comprising a micro-plasma cell with a cavity comprising a plasma in operation when applying a bias to the micro-plasma cell, and read-out electronics connected to the micro-plasma cell measuring changes of an electron density in the plasma in the micro-plasma cell with respect to the bias provided electron density, and
wherein the Penning mixture comprises a main inert gas, and a quench gas having a lower ionization potential than the main inert gas.

36. An image sensor comprising an array having a plurality of detectors, each detector comprising a micro-plasma cell with a cavity comprising a plasma in operation when applying a bias to the micro-plasma cell, and read-out electronics connected to the micro-plasma cell measuring changes of an electron density in the plasma in the micro-plasma cell with respect to the bias provided electron density,
wherein the cavity comprises a gas composition near atmospheric pressure or higher, and the gas composition comprises a Penning mixture.

37. The image sensor of claim 16, wherein the array has a pixel size of between 1 and 500 μm.

38. The image sensor of claim 36, wherein the micro-plasma cells and read-out electronics of each of the array of detectors are formed on a single substrate.

39. The image sensor of claim 36, further comprising imaging optics.

40. The image sensor of claim 36, further comprising an optical window covering the plurality of detectors.
